(19) United States
(12) Patent Application Publication
(10) Pub. No.: US 2024/0177282 A1
(43) Pub. Date: May 30, 2024

(54) VIDEO PROCESSING DEVICE AND DISPLAY DEVICE

(71) Applicant: LAPIS Technology Co., Ltd., Yokohama (JP)

(72) Inventors: Naoki NISHITANI, Yokohama (JP); Yuki IMATOH, Yokohama (JP)

(73) Assignee: LAPIS Technology Co., Ltd., Yokohama (JP)

(21) Appl. No.: 18/518,462

(22) Filed: Nov. 23, 2023

(30) Foreign Application Priority Data
Nov. 30, 2022 (JP) 2022-191423

(51) Int. Cl. G06T 5/00; G06T 5/40; G06T 7/11; G06T 7/13

(52) U.S. Cl. CPC G06T 5/009; G06T 5/40; G06T 7/11; G06T 7/13; G06T 2207/10016

(57) ABSTRACT

A video processing device includes: a local histogram generation part, generating a histogram showing a brightness distribution per pixel for each segmented region of a video including multiple segmented regions, each of which includes multiple pixels; a local tone curve generation part, generating a tone curve for adjusting a brightness of an input video for each segmented region based on the histogram for each segmented region; a luminance boundary region detection part, comparing tone curves between adjacent segmented regions, specifying a boundary between adjacent segmented regions for which a comparison result of the tone curves becomes a predetermined condition as a luminance boundary, and specifying a region within a predetermined range including the luminance boundary as a luminance boundary region; and an video correction part, performing correction processing to correct a luminance of the video based on the tone curve and a specified result of the luminance boundary region.

### CROSS-REFERENCE TO RELATED APPLICATION

This application claims priority under 35 USC 119 from Japanese Patent application No. 2022-191423 filed on Nov. 30, 2022, the disclosure of which is incorporated by reference herein.

### BACKGROUND

### Technical Field

The disclosure relates to a video processing device and a display device.

### Description of Related Art

When converting sensor data of a camera into video data, a process called tone mapping is performed to match the high-resolution video to the color depth that matches the low-resolution display. At that time, a video including a high-luminance region and a low-luminance region is output as one video, so if these regions are adjacent, a so-called “halo”, which is blurring due to the luminance difference between the regions, will occur.

To prevent the occurrence of such halos, a display device has been proposed, which calculates area-specific feature data and pixel-specific feature data for multiple areas of input image data to determine a gamma curve, and then performs an operation to set the luminance of a target pixel to a specific value according to the change from the luminance of the pixels surrounding the target pixel in the luminance image of the input image data (e.g., Patent Document 1, Japanese Patent Application Laid-Open (JP-A) No. 2015-152644).

In the conventional display device described above, even if the difference in luminance between areas is large, if the variation in luminance within the area is small, the difference in tone curve (correction point data) used for correction becomes small. For this reason, there is a problem that a sufficient local correction effect may not be obtained.

The disclosure has been made in view of the above problems and provides a video processing device that may suppress blurring of luminance that occurs between the high-luminance region and the low-luminance region and improve visibility.

### SUMMARY

The video processing device in the disclosure includes: a video processing device, including: a local histogram generation part, generating a histogram showing a brightness distribution per pixel for each segmented region of a video including multiple segmented regions, each of which includes multiple pixels; a local tone curve generation part, generating a tone curve for adjusting a brightness of the video for each of the segmented regions based on the histogram for each of the segmented regions; a luminance boundary region detection part, comparing tone curves between adjacent segmented regions among the segmented regions, specifying a boundary between adjacent segmented regions for which a comparison result of the tone curves becomes a predetermined condition as a luminance boundary, and specifying a region within a predetermined range including the luminance boundary as a luminance boundary region; and an video correction part, performing correction processing to correct a luminance of the video based on the tone curve and a specified result of the luminance boundary region.

The display device in the disclosure includes: a video acquisition part, acquiring a video including multiple segmented regions, each of which includes multiple pixels; a video processing part, performing video processing on the video and generating a display video; and a display part, displaying the display video. The video processing part includes: a local histogram generation part, generating a histogram showing a brightness distribution per pixel for each of the segmented regions of the video; a local tone curve generation part, generating a tone curve for adjusting a brightness of the video for each of the segmented regions based on the histogram for each of the segmented regions; a luminance boundary region detection part, comparing tone curves between adjacent segmented regions among the segmented regions, specifying a boundary between adjacent segmented regions for which a comparison result of the tone curves becomes a predetermined condition as a luminance boundary, and specifying a region within a predetermined range including the luminance boundary as a luminance boundary region; and an video correction part, performing correction processing to correct a luminance of the video based on the tone curve and a specified result of the luminance boundary region.

### BRIEF DESCRIPTION OF THE DRAWINGS

FIG. 1 is a block diagram showing the configuration of the video processing device of this embodiment.

FIG. 2 is a block diagram showing the internal configuration of the video correction LSI.

FIG. 3A is a diagram showing an example of an input video including multiple segmented regions.

FIG. 3B is a diagram showing an example of the histogram of brightness distribution in the segmented regions.

FIG. 3C is a diagram showing an example of the tone curve obtained by converting the histogram.

FIG. 4A is a diagram showing an example of consecutive high-luminance and low-luminance regions.

FIG. 4B is a diagram showing examples of the tone curves of consecutive high-luminance and low-luminance regions.

FIG. 4C is a diagram showing the difference between the tone curves of the high-luminance region and the low-luminance region.

FIG. 5 is a diagram showing examples of the tone curve and the luminance boundary of each of the segmented regions that are consecutive in a horizontal direction.

FIG. 6A is a diagram schematically showing the image correction processing.

FIG. 6B is a diagram showing a calculation example for interpolating the correction value.

### DESCRIPTION OF THE EMBODIMENTS

An exemplary embodiment of the disclosure will be described in detail below. In addition, in the following description of the embodiment and the accompanying drawings, substantially the same or equivalent parts are given the same reference numerals.

The video processing device of the disclosure may suppress blurring of luminance that occurs between the high-luminance region and the low-luminance region and improve visibility.

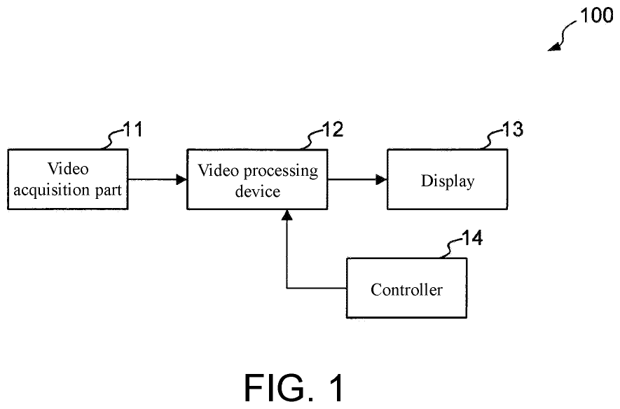

FIG. 1 is a block diagram showing the configuration of the video display system 100 of the disclosure. The video display system 100 includes a video acquisition part 11, a video processing device 12, a display 13, and a controller 14.

The video acquisition part 11 is configured by, for example, a camera and supplies a video signal obtained by photographing to the video processing device 12 as an input video VS.

The video processing device 12 is a processing device that is configured by an LSI (large scale integration) and performs correction processing on the input video VS supplied from the video acquisition part 11. The video processing device 12 supplies video data obtained by performing correction processing on the input video VS to the display 13 as an output video VD.

The display 13 is configured by, for example, a liquid crystal display device and displays the output video VD output from the video processing device 12.

The controller 14 is configured by an MCU (micro controller unit) and controls the video correction processing by the video processing device 12.

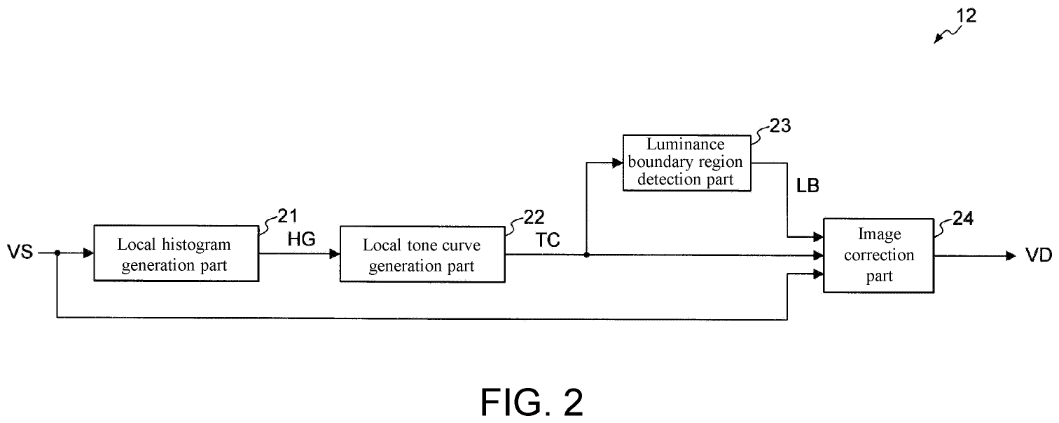

FIG. 2 is a block diagram showing the configuration of the video processing device 12. The video processing device 12 includes a local histogram generation part 21, a local tone curve generation part 22, a luminance boundary region detection part 23, and an image correction part 24.

The local histogram generation part 21 receives the supply of the input video VS and generates a histogram HG indicating the brightness distribution for each of the regions (hereinafter referred to as the segmented regions) obtained by segmenting the video region of the input video VS.

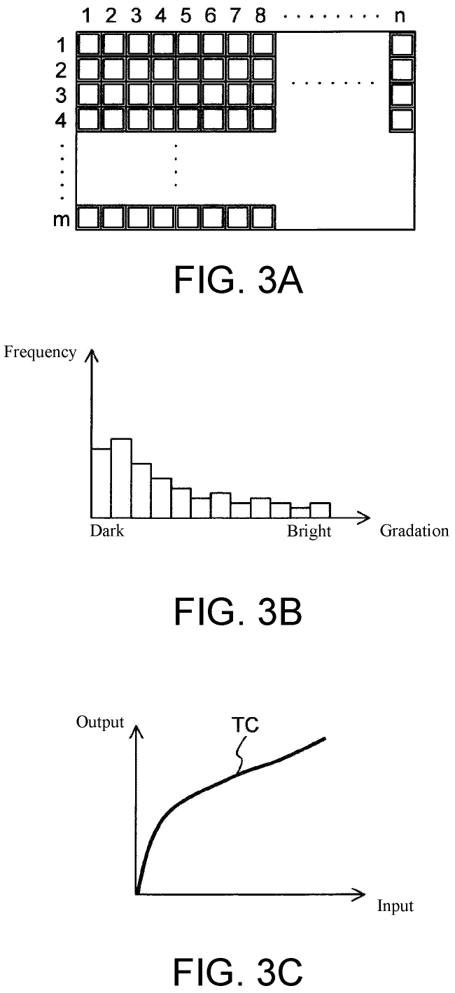

FIG. 3A is a diagram showing an example of the input video VS. The input video VS is configured by m×n (vertical m, horizontal n) segmented regions. Each of the segmented regions is configured with multiple pixels.

FIG. 3B is a diagram showing an example of the histogram HG generated by the local histogram generation part 21. The horizontal axis indicates the gradation, and the vertical axis indicates the frequency at which the gradation exists within the segmented region (i.e., the number of pixels). Here, a case is shown as an example in which a large number of pixels of relatively dark gradation are distributed in a segmented region.

The local tone curve generation part 22 generates a tone curve TC for adjusting the brightness of the input video VS for each of the segmented regions based on the histogram HG for each of the segmented regions generated by the local histogram generation part 21. It should be noted that the tone curve TC used in this embodiment is determined according to the histogram HG of the brightness distribution. That is, the local tone curve generation part 22 converts the histogram HG of the brightness distribution for each of the segmented regions using a predetermined function to generate the tone curve TC of each of the segmented regions.

FIG. 3C is a diagram showing an example of the tone curve TC corresponding to the histogram HG in FIG. 3B. As described above, the histogram HG in FIG. 3B has many pixels with relatively dark gradation, so the corresponding tone curve TC has a shape in which the slope is larger in the low input value region (dark input value) and becomes smaller in the high input value region (bright input value).

Referring to FIG. 2 again, the luminance boundary region detection part 23 compares the tone curves TC of adjacent segmented regions within the tone curves TC of multiple segmented regions and specifies the boundary part (hereinafter referred to as the luminance boundary) where the luminance difference between the segmented regions is large based on the comparison result. The luminance boundary region detection part 23 specifies (detects) the region within a predetermined range including the specified luminance boundary as a luminance boundary region LB. The luminance boundary region detection part 23 supplies information of the luminance boundary region LB to the image correction part 24.

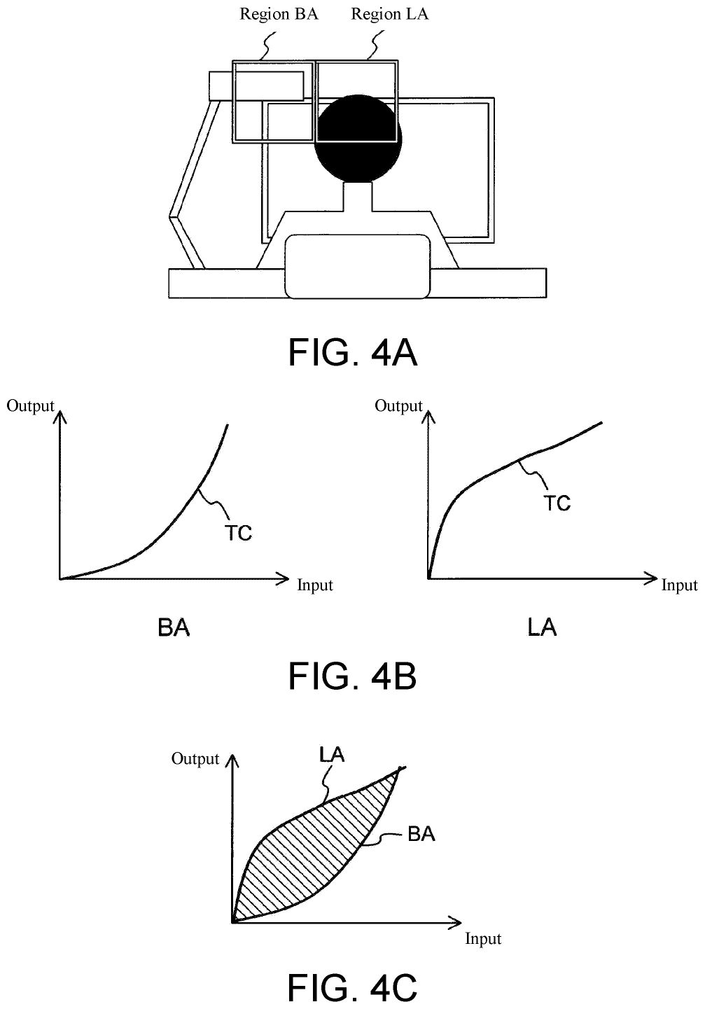

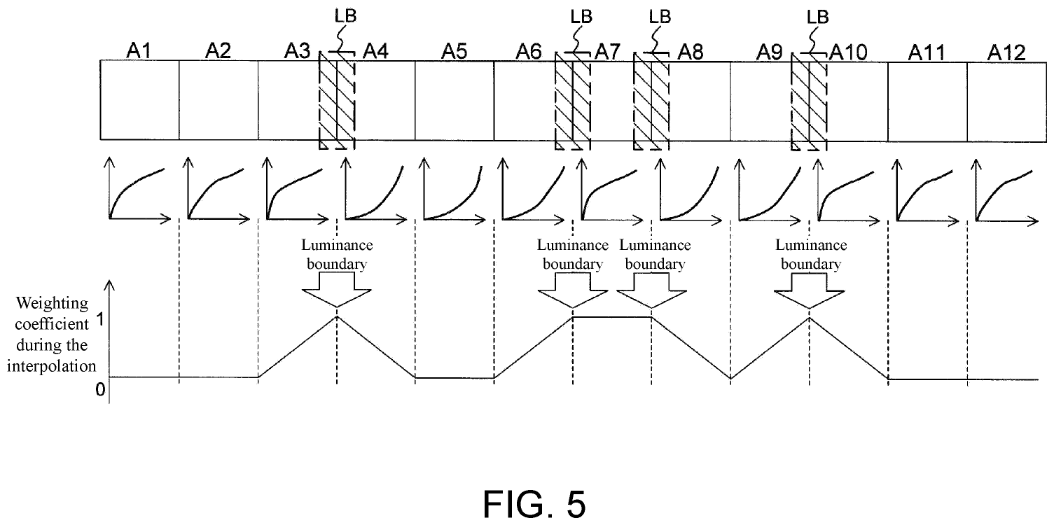

The process of detecting the luminance boundary region LB executed by the luminance boundary region detection part 23 is described with reference to FIG. 4A to FIG. 4C and FIG. 5.

FIG. 4A shows an example of a large luminance difference between adjacent segmented regions, that is, consecutive high-luminance and low-luminance regions. Here, the high-luminance region BA including the light of a desk lamp and the low-luminance region LA including much of the back of a human head, which is black, are configured adjacent to each other.

FIG. 4B is a diagram showing examples of the tone curves TC of each of the high-luminance region BA and the low-luminance region LA. The horizontal axis represents the input value, and the vertical axis represents the output value. The tone curve TC of the high-luminance region BA has a shape in which the slope is smaller in the low input value region (dark input values) and becomes larger in the high input value region (bright input values). On the other hand, the tone curve TC of the low-luminance region LA has a shape in which the slope is larger in the low input value region and becomes smaller in the high input value region.

FIG. 4C is a diagram showing the difference between the tone curve TC of the high-luminance region BA and the tone curve TC of the low-luminance region LA. As shown by the diagonal lines in the figure, since the transition of the slope of the tone curves TC is greatly different between the high-luminance region BA and the low-luminance region LA, the difference is large. The luminance boundary region detection part 23 specifies the luminance boundary based on the difference in the tone curves TC between such adjacent segmented regions.

Specifically, the area of the part surrounded by the two tone curves TC (e.g., the diagonal lines shown in FIG. 4C) is the difference of the tone curves TC. That is, when the tone curve TC of each of the two adjacent segmented regions are illustrated on the same coordinate, the luminance boundary region detection part 23 specifies the boundary between the segmented regions as the luminance boundary in response to the area of the region surrounded by the two tone curves being greater than a predetermined threshold value.

The luminance boundary region detection part 23 detects a region within the predetermined range including the specified luminance boundary as the luminance boundary region LB. For example, in the case of a luminance boundary between horizontally adjacent segmented regions, the region of predetermined pixel rows sandwiches the luminance boundary and becomes the luminance boundary region LB.

FIG. 5 is a diagram showing examples of the tone curves TC and the luminance boundaries of the segmented regions that are consecutive. Here, a case is shown in which segmented regions A1 to A12 are consecutive in a horizontal direction.

The tone curves TC of the segmented regions A1 to A3 have a shape in which the slope is larger in the low input value range and becomes smaller as the input value increases. That is, the segmented regions A1 to A3 are regions with relatively low luminance. Furthermore, the difference between the tone curves TC of the segmented regions A1 and A2 and the difference between the tone curves TC of the segmented regions A2 and A3 are both small.

The tone curves TC of the segmented regions A4 to A6 have a shape in which the slope is smaller in the low input value range and becomes larger as the input value increases. That is, the segmented regions A4 to A6 are regions with relatively high luminance. Furthermore, the difference between the tone curves TC of the segmented regions A4 and A5 and the difference between the tone curves TC of the segmented regions A5 and A6 are both small.

In contrast, the boundary where the segmented region A3 and the segmented region A4 are adjacent to each other has a large difference because the segmented region A3 is a low-luminance region and the segmented region A4 is a high-luminance region and the shape of the tone curves TC are very different. In other words, when each of the tone curves TC of the segmented regions A3 and A4 is displayed on the same coordinate, the area of the part surrounded by the two tone curves TC exceeds the threshold value. The luminance boundary region detection part 23 specifies the boundaries of the segmented regions A3 and A4 as the luminance boundary and detects a region within the predetermined range including the specified luminance boundary as the luminance boundary region LB.

Similarly, the luminance boundary region detection part 23 specifies the luminance boundaries based on the difference of the tone curves TC between adjacent segmented regions in the segmented regions A4 to A12 and detects the luminance boundary regions LB. As a result, the luminance boundaries between the segmented region A6, which is the high-luminance region, and the segmented region A7, which is the low-luminance region, between the segmented region A7, which is the low-luminance region, and the segmented region A8, which is the high-luminance region, and between the segmented region A9, which is the high-luminance region, and the segmented region A10, which is the low-luminance region, are specified respectively. The luminance boundary region detection part 23 detects the regions within the predetermined range including the specified luminance boundaries as the luminance boundary regions LB.

For the pixel located in the luminance boundary region LB, during the correction processing executed by the image correction part 24, interpolation of the correction value is performed after weighting the correction value calculated based on the tone curve by a weighting coefficient of “1”. On the other hand, for the pixel located in the region other than the luminance boundary region LB, the weighting coefficient during the interpolation of the correction value is “0”.

It should be noted that although FIG. 5 shows the case where the segmented regions are consecutive in the horizontal direction, the luminance boundary region detection part 23 similarly specifies the luminance boundaries and detects the luminance boundary regions LB for the segmented regions that are consecutive in the vertical direction.

Referring to FIG. 2 again, the image correction part 24 calculates the correction value for each of the pixels and performs the correction processing on the input video VS. At that time, the image correction part 24 performs the interpolation of the correction value while changing the weighting coefficient based on whether the pixel to be processed is located in the luminance boundary region LB.

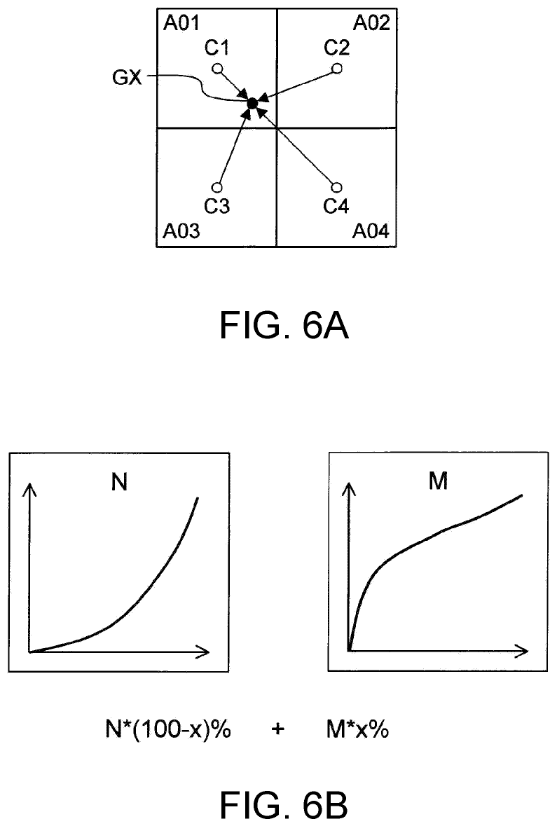

The calculation of the correction value for each of the pixels performed by the image correction part 24 is described with reference to FIG. 6A and FIG. 6B.

FIG. 6A is a diagram showing a simplified view of the segmented region to which the pixel GX, which is the target pixel for the calculation of the correction value, belongs and the surrounding segmented regions. The pixel GX is located in the segmented region A01. The segmented region A01 is adjacent to the segmented region A02 in the horizontal direction (i.e., in the horizontal direction of the paper). Further, the segmented region A01 is adjacent to the segmented region A03 in the vertical direction (i.e., in the vertical direction of the paper). The segmented region A03 and the segmented region A04 are adjacent to each other in the horizontal direction (horizontal direction of the page), and the segmented region A02 and the segmented region A04 are adjacent to each other in the vertical direction (vertical direction of the page). C1 represents the center position of the segmented region A01, C2 represents the center position of the segmented region A02, C3 represents the center position of the segmented region A03, and C4 represents the center position of the segmented region A04, respectively.

The image correction part 24 calculates the correction value of the pixel GX using the tone curve TC of the segmented region A01 in which the pixel GX, which is the target pixel for the calculation of the correction value, is located and the tone curves TC of the segmented regions A02 to A04 adjacent to the segmented region A01. At that time, the image correction part 24 calculates the correction value of the pixel GX by interpolating the correction value obtained from the tone curve TC of each of the segmented regions A01 to A04 based on the distance from the center positions C1 to C4 of each of the segmented regions to the pixel GX.

FIG. 6B is a diagram showing a calculation example for interpolating the correction value. Here, in order to simplify the description, a calculation example focusing only on the horizontal direction is shown. For example, when the region of the tone curve TC corresponding to the correction value “N” is adjacent to the region of the tone curve TC corresponding to the correction value “M”, the image correction part 24 calculates the correction value by mixing these values in a ratio based on the distances “x” from the target pixel of the correction processing to each of the segmented regions. The correction value CV is CV=N*(100−x) %+M*x %.

When the pixel GX is located in a region other than the luminance boundary region LB, the image correction part 24 performs the correction processing for the pixel GX using the correction value calculated based on the distances from the center positions of the segmented region in which the pixel GX is located and the segmented regions adjacent thereto.

On the other hand, when the pixel GX is located in the luminance boundary region LB, in addition to the distances from the center positions of the adjacent segmented regions as described above, the image correction part 24 performs the interpolation of the correction value after weighting the same so that the influence of the segmented region A01, where the pixel GX is located, is greater. As a result, the correction value obtained for the pixels in the luminance boundary region LB largely reflects the luminance of the segmented region in which each pixel is located.

The image correction part 24 outputs a video obtained by performing the correction processing on the input video VS as the output video VD. As described above, for the pixel within the luminance boundary region LB, the correction processing is performed using a correction value that greatly reflects the luminance of the segmented region in which the pixel is located. For this reason, the luminance boundary changes sharply during the interpolation of image correction, and the width of the halo (blurring of luminance) that occurs at the boundary part between the high-luminance region and the low-luminance region becomes smaller.

As described above, the video processing device 12 of this embodiment calculates the correction value for each of the pixels of the input video VS, performs correction processing, and generates the output video VD. At that time, based on the tone curve TC generated for each of the segmented regions obtained by segmenting the video region of the input video, the region in the boundary part where the luminance difference between the regions is large is detected as the luminance boundary region LB. Then, for a pixel existing within the luminance boundary region LB, the correction value is calculated after weighting is performed so that the influence of the luminance of the region to which the pixel belongs is increased. According to this configuration, the image correction processing is performed to emphasize the luminance difference in the boundary part between the high-luminance region and the low-luminance region, and the output video VD is generated.

Therefore, according to the video processing device 12 of this embodiment, blurring of luminance (so-called halo) that occurs between the high-luminance region and the low-luminance region is suppressed, and the visibility is improved.

It should be noted that the disclosure is not limited to the embodiment described above. For example, the calculation formula for the correction value shown in FIG. 6B is an example, and the calculation for interpolating the correction value is not limited thereto.

In addition, in the above embodiment, the case in which weighting during interpolation is performed so that the influence of the tone curve of the segmented region in which the pixel is located is increased for the pixel included in the luminance boundary region LB is described as an example. However, the weighting method is not limited thereto. For example, the segmented region may be further segmented into multiple blocks and a tone curve may be generated for each of the blocks, the difference between the tone curve of the block to be processed (the block to which the pixel to be processed belongs) and the tone curves of the surrounding blocks may be calculated, and weighting during the interpolation may be performed so that the influence of the tone curves of the surrounding blocks with smaller differences increases.

What is claimed is:

1. A video processing device, comprising:
a local histogram generation part, generating a histogram showing a brightness distribution per pixel for each segmented region of a video comprising a plurality of segmented regions, each of which comprises a plurality of pixels;
a local tone curve generation part, generating a tone curve for adjusting a brightness of the video for each of the segmented regions based on the histogram for each of the segmented regions;
a luminance boundary region detection part, comparing tone curves between adjacent segmented regions among the segmented regions, specifying a boundary between adjacent segmented regions for which a comparison result of the tone curves becomes a predetermined condition as a luminance boundary, and specifying a region within a predetermined range including the luminance boundary as a luminance boundary region; and
a video correction part, performing correction processing to correct a luminance of the video based on the tone curve and a specified result of the luminance boundary region.

2. The video processing device according to claim 1, wherein for each of the pixels, the video correction part calculates a correction value for each of the pixels based on the tone curves of the segmented region to which the pixel belongs and surrounding segmented regions adjacent to the segmented region and the specified result of the luminance boundary region and corrects the luminance of the video based on the calculated correction value for each of the pixels.

3. The video processing device according to claim 2, wherein for each of the pixels, the video correction part interpolates the tone curves of the segmented region to which the pixel belongs and the surrounding segmented regions adjacent to the segmented region based on distances from center positions of the segmented region to which the pixel belongs and the surrounding segmented regions and calculates the correction value for each of the pixels by performing weighting during interpolation based on whether the pixel belongs to the luminance boundary region or not.

4. The video processing device according to claim 1, wherein the luminance boundary region detection part detects a difference between the tone curves of the adjacent segmented regions and specifies the luminance boundary based on the detected difference between the tone curves.

5. The video processing device according to claim 2, wherein the luminance boundary region detection part detects a difference between the tone curves of the adjacent segmented regions and specifies the luminance boundary based on the detected difference between the tone curves.

6. The video processing device according to claim 3, wherein the luminance boundary region detection part detects a difference between the tone curves of the adjacent segmented regions and specifies the luminance boundary based on the detected difference between the tone curves.

7. The video processing device according to claim 4, wherein the luminance boundary region detection part detects the difference between the tone curves based on an area of a region surrounded by the tone curves in response to the tone curve of each of the adjacent segmented regions being represented on a same coordinate.

8. A display device, comprising:
a video acquisition part, acquiring a video comprising a plurality of segmented regions, each of which comprises a plurality of pixels;
a video processing part, performing video processing on the video and generating a display video; and
a display part, displaying the display video, and
wherein the video processing part comprises:
a local histogram generation part, generating a histogram showing a brightness distribution per pixel for each of the segmented regions of the video;
a local tone curve generation part, generating a tone curve for adjusting a brightness of the video for each of the segmented regions based on the histogram for each of the segmented regions;
a luminance boundary region detection part, comparing tone curves between adjacent segmented regions among the segmented regions, specifying a boundary between adjacent segmented regions for which a comparison result of the tone curves becomes a predetermined condition as a luminance boundary, and specifying a region within a predetermined range including the luminance boundary as a luminance boundary region; and
a video correction part, performing correction processing to correct a luminance of the video based on the tone curve and a specified result of the luminance boundary region.
